(19) United States
(12) Patent Application Publication
(10) Pub. No.: US 2020/0206787 A1
(43) Pub. Date: Jul. 2, 2020

(54) DUST CLEANING ROBOT

(71) Applicant: DMBH Co., Ltd., Bucheon-si (KR)

(72) Inventors: YONG GIL PARK, Seongnam-si (KR); SEUNG KUK KIM, Bucheon-si (KR)

(73) Assignee: DMBH Co., Ltd., Bucheon-si (KR)

(21) Appl. No.: 16/253,236

(22) Filed: Jan. 22, 2019

(30) Foreign Application Priority Data
Dec. 28, 2018 (KR) 10-2018-0173111

(51) Int. Cl. B08B 1/00; B25J 11/00

(52) U.S. Cl. CPC B08B 1/008; B25J 11/0085; B08B 1/002

(57) ABSTRACT

Provided is a dust cleaning robot for removing dust built up on dust collecting plates facing each other at a predetermined interval. The dust cleaning robot includes: a rail arranged on sides of the dust collecting plates; and a transfer robot running along the rail and having a climbing cleaning robot for cleaning up dust built up on the dust collecting plates while climbing the sides of the dust collecting plates.

### BACKGROUND OF THE INVENTION

### Field of the Invention

The present invention relates to a dust cleaning robot, and more particularly, to a dust cleaning robot capable of removing dust or foreign matters built up on dust collecting plates facing each other at a regular interval.

### Background Art

In general, dust collectors are installed in a factory, which discharges harmful air, in order to discharge clean air after purifying harmful elements, such as dust or foreign matters, contained in the air.

Such a dust collector applies an electric current in order to collect dust or foreign matters onto dust collecting plates made of iron by static electricity.

After a predetermined period of time, because dust or foreign matters are built up on the dust collecting plates and it deteriorates air purifying function, a worker has to directly clean dust or foreign matters built up on the dust collecting plates.

However, it is very difficult for the worker to enter the space between the dust collecting plates to clean up since a space between the dust collecting plates is narrow, and cleaning efficiency is low since the worker hits the dust collecting plates to remove dust or foreign matters.

### PATENT LITERATURE

### Patent Documents

Patent Document 1: Korean Patent No. 10-1338381

Patent Document 1: Korean Patent No. 10-0993004

Patent Document 1: Korean Patent Publication No. 10-2011-0017512

### SUMMARY OF THE INVENTION

Accordingly, the present invention has been made to solve the above-mentioned problems occurring in the prior arts, and it is an object of the present invention to provide a dust cleaning robot, which includes a rail arranged on sides of dust collecting plates; and a transfer robot running along the rail and having a climbing cleaning robot which climbs sides of the dust collecting plates to remove dust built up on the dust collecting plates.

However, objects of the present invention are not limited to the objects described above, and other objects that are not described will be clearly understood by a person skilled in the art from the description below.

To accomplish the above object, according to the present invention, there is provided a dust cleaning robot for removing dust built up on dust collecting plates facing each other at a predetermined interval, the dust cleaning robot including: a rail arranged on sides of the dust collecting plates; and a transfer robot running along the rail and having a climbing cleaning robot for cleaning up dust built up on the dust collecting plates while climbing the sides of the dust collecting plates.

Moreover, the transfer robot includes: a running body of a plate shape; a stage part moving the climbing cleaning robot in an X-axis direction, which is a lateral direction of the dust collecting plates, so that the climbing cleaning robot is fixed on outer walls of the dust collecting plates; a combining part combined with an upper side of the running body in order to locate the stage part at a predetermined height from the upper side of the running body; a running device arranged between the running body and the stage part to move the running body in a Y-axis direction (in a back-and-forth direction); and a running guide part combined with a lower side of the running body so as to guide the transfer robot to run along the rail by the running device.

Furthermore, the rail includes: a horizontal plate formed long in a Y-axis direction; and a vertical plate extending downwardly from right and left sides of the horizontal plate to support the ground, and the running device is seated and operated on the horizontal plate, and the running guide part supports the outer surface of the vertical plate.

Additionally, the stage part includes: a first driving part combined with one side of the upper side of the running body to generate driving power; a base plate combined with the combining part; a seating plate disposed at an upper side of the base plate, wherein the climbing cleaning robot is seated on the seating plate; and a transfer guide part for moving the seating plate in an X-axis direction by operation of the first driving part.

In addition, the running device includes: a second driving part combined with the other side of the upper portion of the running body to generate driving power; a power transferring means for transferring driving power of the second driving part; and a plurality of driving wheels connected with the power transferring means to rotate by receiving the driving power from the second driving part.

Moreover, the running guide part includes: one or more pairs of bracket parts combined with both sides of the floor surface of the running body; rollers combined with the bracket parts and rotating in contact with the vertical plate of the rail; and a combining means for combining the bracket parts with the running body to adjust a distance between a pair of the bracket parts.

Furthermore, the combining part includes: a plurality of supporters vertically combined with the upper side of the running body and penetrating through a through hole formed in the base plate; and a stopper combined with the supporters to fix the base plate at a predetermined height.

Additionally, the base plate includes: a clamping device mounted at the upper side thereof to combine and fix the supporters protruding to penetrate through the through holes; and a cap disposed on the floor surface of the base plate, wherein the inner circumferential surface of the cap is formed to correspond to the outer circumferential surface of the stopper.

In addition, the stopper surrounds the outer circumferential surface of the supporters, and the outer circumferential surface of the stopper is outwardly inclined in a radial direction toward a lower portion.

Moreover, the first driving part includes: a motor for generating driving power; a motor shaft vertically formed at an upper portion of the motor to rotate by driving power of the motor; and a pinion gear combined with the motor shaft.

Furthermore, the transfer guide part includes: a pair of guide bars combined with an upper side of the base plate to be spaced apart from each other at a predetermined interval in the X-axis direction and having guide holes formed therein; a pair of slide bars combined with a floor surface of the seating plate and having protrusions corresponding to the guide holes of the guide bars; and a rack bar combined with an inner face of one among the slide bars, having gear teeth to be geared with the pinion gear.

Furthermore, the running body has driving holes formed at positions corresponding to the plurality of driving wheels, and the driving wheels are arranged such that lower portions of the driving wheels are exposed downwardly from the running body by the driving holes and rotate by getting in contact with the horizontal plate of the rail.

Additionally, the power transferring means upper side of the running body; wheel shafts for connecting the driving wheels with the frame part; and a transfer pulley combined with the wheel shafts and connected to a driving pulley combined with the motor shaft of the second driving part via a belt.

The above and other objects, features and advantages of the present invention will be more clearly understood from the following detailed description taken in conjunction with the accompanying drawings.

The terms and words used in the specification and claims must not be limited to typical or dictionary meanings, but must be regarded as concepts selected by the inventor as concepts which best illustrate the present invention, and must be interpreted as having meanings and concepts adapted to the scope and spirit of the present invention to aid in understanding the technology of the present invention.

According to the present invention, the dust cleaning robot can reduce weight of the transfer robot for carrying since the dust cleaning robot can be disassembled, and extend its lifespan by preventing breakdown or damage of the transfer robot.

In addition, the dust cleaning robot according to the present invention can expand a use scope since coping with various widths of the rail by adjusting the width of the running guide part.

### BRIEF DESCRIPTION OF THE DRAWINGS

The above and other objects, features and advantages of the present invention will be apparent from the following detailed description of the preferred embodiments of the invention in conjunction with the accompanying drawings, in which:

FIG. 1 is a perspective view showing a dust cleaning robot according to a preferred embodiment of the present invention;

FIG. 2 is a front view showing a combining structure of the dust cleaning robot and a rail according to the preferred embodiment of the present invention;

FIGS. 3 and 4 are perspective views showing a stage part of the dust cleaning robot according to the preferred embodiment of the present invention;

FIG. 5 is a sectional view showing a combining structure between a combining part and a base plate of the dust cleaning robot according to the preferred embodiment of the present invention;

FIG. 6 is a perspective view of a running device of the dust cleaning robot according to the preferred embodiment of the present invention;

FIG. 7 is a side view showing the running device of the dust cleaning robot according to the preferred embodiment of the present invention; and

FIG. 8 is a partially perspective view showing a combining structure (a) between a running guide part and a running body and a process (b) of adjusting the width of the running guide part.

### DETAILED DESCRIPTION OF THE PREFERRED EMBODIMENT

Hereinafter, preferred embodiments of the present invention will be described in detail with reference to the accompanying drawings. In the drawings, thicknesses of lines and sizes of constituent elements may be exaggerated for clarity and convenience in explanation.

Further, wordings to be described later are defined in consideration of the functions of the present invention, and may differ depending on the intentions of a user or an operator or custom. Accordingly, such wordings should be defined on the basis of the contents of the overall specification.

In addition, the embodiment disclosed hereinafter does not limit the scope of the present invention, but corresponds to merely exemplary terms of constituent elements presented in claims of the present invention, and the embodiments that include replaceable constituent elements as equivalents of the constituent elements defined in the overall specification and claims may be included in the scope of the present invention.

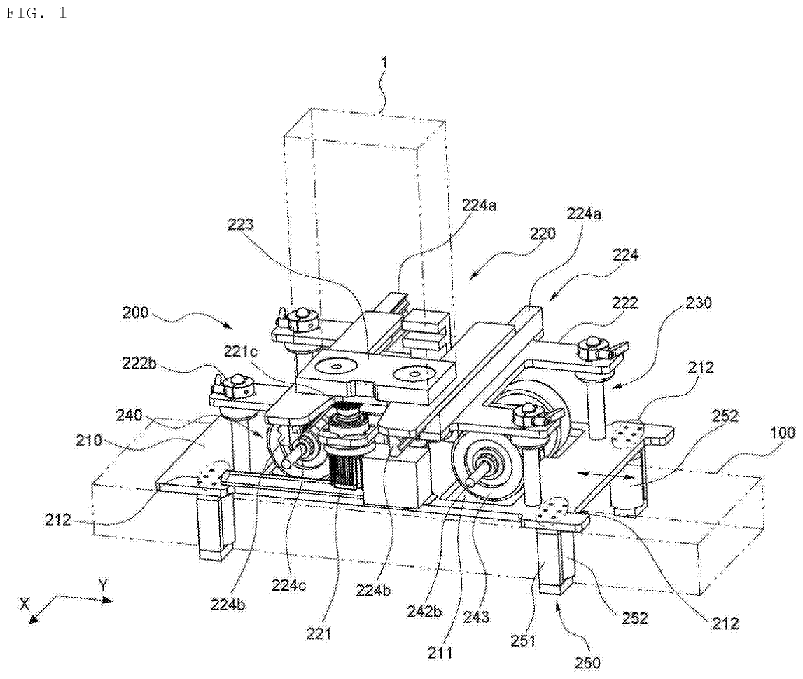

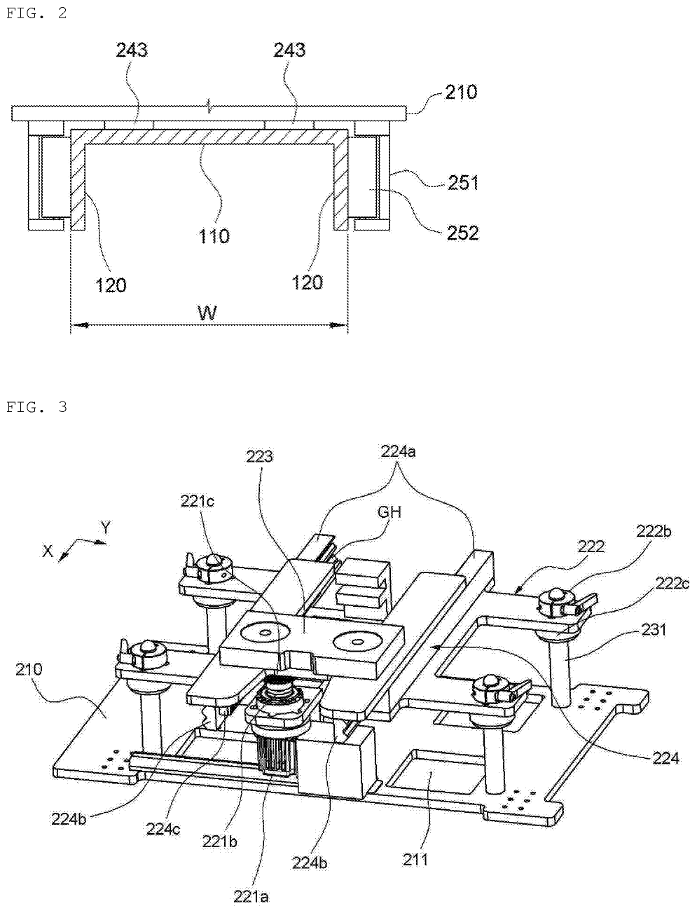

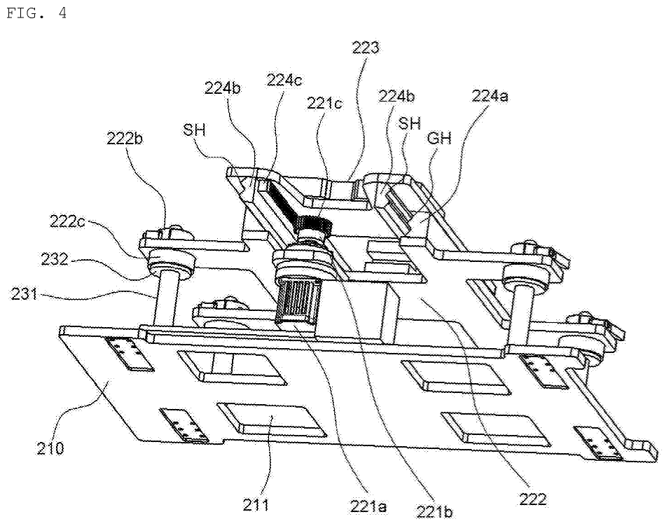

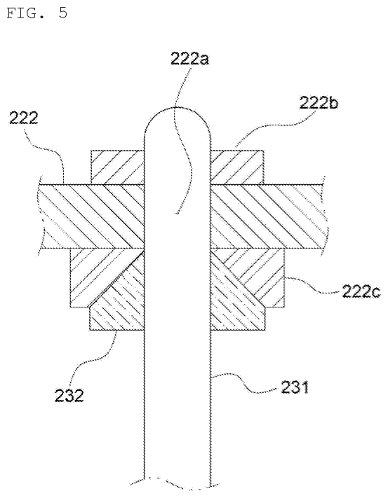

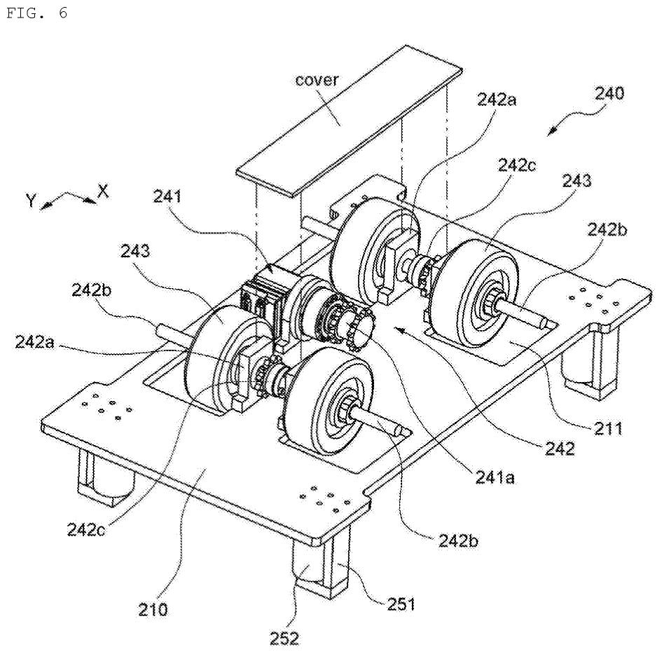

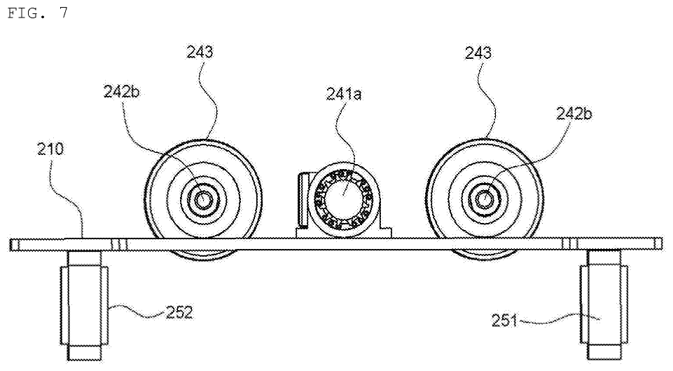

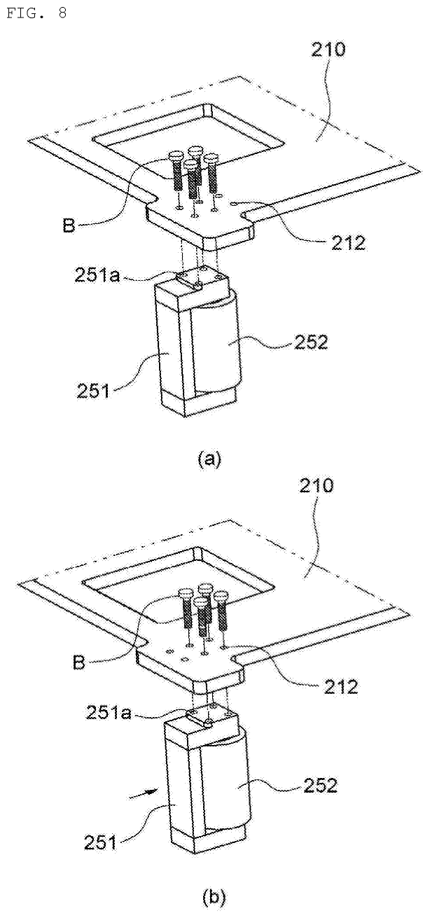

FIG. 1 is a perspective view showing a dust cleaning robot according to a preferred embodiment of the present invention, FIG. 2 is a front view showing a combining structure of the dust cleaning robot and a rail according to the preferred embodiment of the present invention, FIGS. 3 and 4 are perspective views showing a stage part of the dust cleaning robot according to the preferred embodiment of the present invention, FIG. 5 is a sectional view showing a combining structure between a combining part and a base plate of the dust cleaning robot according to the preferred embodiment of the present invention, FIG. 6 is a perspective view of a running device of the dust cleaning robot according to the preferred embodiment of the present invention, FIG. 7 is a side view showing the running device of the dust cleaning robot according to the preferred embodiment of the present invention, and FIG. 8 is a partially perspective view showing a combining structure (a) between a running guide part and a running body and a process (b) of adjusting the width of the running guide part.

As shown in FIG. 1, a dust cleaning robot according to the preferred embodiment of the present invention includes: a rail 100 arranged on sides of dust collecting plates arranged to face each other at a predetermined interval; and a transfer robot 200 running along the rail 100 and having a climbing cleaning robot 1 for cleaning up dust built up on the dust collecting plates while climbing the sides of the dust collecting plates.

Moreover, the transfer robot 200 includes a running body 210, a stage part 220, a combining part 230, a running device 240, and a running guide part 250.

The running body 210 is formed in a plate shape and is a base frame of the transfer robot 200.

Furthermore, the stage part 220 moves the climbing cleaning robot in an X-axis direction, which is a lateral direction of the dust collecting plates, so that the climbing cleaning robot can be fixed on outer walls of the dust collecting plates.

Additionally, the combining part 230 is combined with an upper side of the running body 210 in order to locate the stage part 220 at a predetermined height from the upper side of the running body 210.

In addition, the running device 240 is arranged between the running body 210 and the stage part 220 to move the running body 210 in a Y-axis direction, namely in a back-and-forth direction, along the rail 100.

Moreover, the running guide part 250 is combined with a lower side of the running body 210 so as to guide the transfer robot 200 to run along the rail 100 by the running device 240.

In this instance, the climbing cleaning robot 1 includes: a combining plate seated on the stage part 220; a cleaning robot body disposed at an upper portion of the combining plate; a brush part disposed at an upper portion of the cleaning robot body; a fixing means for fixing the climbing cleaning robot on the dust collecting plates; and a lifting means fixed on the dust collecting plates by the fixing means in order to lift up and lower the climbing cleaning robot. Because such a structure of the climbing cleaning robot has been described in Korean Patent Application No 10-2017-0177394, a detailed description of the structure of the climbing cleaning robot will be omitted.

Moreover, the rail 100 includes a horizontal plate 110 formed long in a Y-axis direction, and a vertical plate 120 extending downwardly from right and left sides of the horizontal plate 110 to support the ground.

That is, has a cross section of a ‘⊏’ shape or a ‘≡’ shape.

Furthermore, the running device 240 is seated and operated on the horizontal plate 110, and the running guide part 250 supports the outer surface of the vertical plate 120, so that the transfer robot 200 runs along the rail 100.

In the meantime, the stage part 220 includes: a first driving part 221 combined with one side of the upper side of the running body 210 to generate driving power; a base plate 222 combined with the combining part 230; a seating plate 223 disposed at an upper side of the base plate 222, wherein the climbing cleaning robot is seated on the seating plate 223; and a transfer guide part 224 for moving the seating plate in an X-axis direction by operation of the first driving part 221.

In this instance, the first driving part 221 includes: a motor 221a for generating driving power; a motor shaft 221b vertically formed at an upper portion of the motor 221 to rotate by driving power of the motor 221a; and a pinion gear 221c combined with the motor shaft 221b.

Moreover, the transfer guide part 224 includes: a pair of guide bars 224a combined with an upper side of the base plate 222 to be spaced apart from each other at a predetermined interval in the X-axis direction and having guide holes (GH) formed therein; a pair of slide bars 224b combined with a floor surface of the seating plate 223 and having protrusions (SH) corresponding to the guide holes (GH) of the guide bars 224a; and a rack bar 224c combined with an inner face of one among the slide bars 224b, having gear teeth to be geared with the pinion gear 221c.

Therefore, when the pinion gear 221c rotates, the rack bar 224c geared with the pinion gear 221c does a rectilinear motion in the X-axis direction.

Furthermore, the slide bars 224b combined with the rack bar 224c also do a rectilinear motion in the X-axis direction to transfer the seating plate 223.

In the meantime, the combining part 230 includes: a plurality of supporters 231 vertically combined with the upper side of the running body 210 and penetrating through a through hole 222a formed in the base plate 222; and a stopper 232 combined with the supporters 231 to fix the base plate 222 at a predetermined height.

Additionally, the base plate 222 includes: a clamping device 222b mounted at the upper side thereof to combine and fix the supporters 231 protruding to penetrate through the through holes 222a; and a cap 222c disposed on the floor surface of the base plate 222, wherein the inner circumferential surface of the cap 222c is formed to correspond to the outer circumferential surface of the stopper 232.

In addition, preferably, the stopper 232 surrounds the outer circumferential surface of the supporters 231, wherein the outer circumferential surface of the stopper 232 is outwardly inclined in a radial direction toward a lower portion, and the inner circumferential surface of the cap 222c is also inclined to have a tapered slope.

That is, the base plate 222 can be fit and mounted to the combining part 230, and the slide part 220 can be located at the upper portion of the running body 210 to a predetermined height by the structure of the stopper 232, so that the slide part 220 can be easily assembled and disassembled.

In the meantime, the running device 240 includes: a second driving part 241 combined with the other side of the upper portion of the running body 210 to generate driving power; a power transferring means 242 for transferring driving power of the second driving part 241; and a plurality of driving wheels 243 connected with the power transferring means 242 to rotate by receiving the driving power from the second driving part 241.

Moreover, the running body 210 has driving holes 211 formed at positions corresponding to the plurality of driving wheels 243, and the driving wheels 243 are arranged such that lower portions of the driving wheels 243 are exposed downwardly from the running body 210 by the driving holes 211 and rotate by getting in contact with the horizontal plate 110 of the rail 100 in order to move the running body 210.

In this instance, the driving holes 211 have a sufficient size not to interfere rotation of the driving wheels 243.

Furthermore, the power transferring means 242 includes a frame part 242a combined with a central portion of the upper side of the running body 210; wheel shafts 242b for connecting the driving wheels 243 with the frame part 242a; and a transfer pulley 242c combined with the wheel shafts 242b and connected to a driving pulley 241a combined with the motor shaft of the second driving part 241 via a belt (not shown).

Additionally, the driving wheels 243 may be formed in a pair, and the wheel shafts 242b penetrate the frame part 242a and may be combined by the medium of a bearing.

In addition, a pair of the driving wheels 243 are combined with both sides of one wheel shaft 242b, and the frame part 242a supports the wheel shaft 242b inside a pair of the driving wheels 243.

In the meantime, the running guide part 250 includes: one or more pairs of bracket parts 251 combined with both sides of the floor surface of the running body 210; rollers 252 combined with the bracket parts 251 and rotating in contact with the vertical plate 120 of the rail 100; and a combining means for combining the bracket parts 251 with the running body 210 to adjust a distance (W) between a pair of the bracket parts 251.

In addition, the bracket part 251 and the running body 210 respectively have bolt coupling holes 251a and 212, and coupling bolts B are inserted into the bolt coupling holes 251a and 212 of the bracket part 251 and the running body 210 so that the combining means is connected.

Moreover, the bolt coupling holes 212 formed in the running body 210 are formed in the plural at regular intervals so that the running body 210 is combined with the bracket part 251 by the medium of the coupling bolts B so as to adjust the distance (W) between the rollers 252.

Furthermore, each of the bracket parts 251 includes a first bracket disposed at an upper portion of the roller 252 and combined with the running body 210; a second bracket disposed at a lower portion of the roller 252; and a connection bracket for connecting the first bracket and the second bracket with each other.

Additionally, a rotary shaft of the roller 252 is supported and combined by the medium of the first bracket and the second bracket, and the roller 252 and the rotary shaft of the roller may be combined with each other by the medium of a bearing.

Therefore, the dust cleaning robot according to the present invention can cope with various widths of the rail 100 since the rollers 252 rotate around a vertically central axis of the rotary shaft and the width (W) between the rollers 252 can be adjusted by the combining means.

Although exemplary embodiments of the present invention have been disclosed for illustrative purposes, it will be appreciated that the present invention is not limited thereto, and those skilled in the art will appreciate that various modifications, additions and substitutions are possible, without departing from the scope and spirit of the invention.

Accordingly, any and all modifications, variations or equivalent arrangements should be considered to be within the scope of the invention, and the detailed scope of the invention will be disclosed by the accompanying claims.

What is claimed is:

1. A dust cleaning robot for removing dust built up on dust collecting plates facing each other at a predetermined interval, the dust cleaning robot comprising:
a rail arranged on sides of the dust collecting plates; and
a transfer robot running along the rail and having a climbing cleaning robot for cleaning up dust built up on the dust collecting plates while climbing the sides of the dust collecting plates.

2. The dust cleaning robot according to claim 1, wherein the transfer robot comprises:
a running body of a plate shape;
a stage part moving the climbing cleaning robot in an X-axis direction, which is a lateral direction of the dust collecting plates, so that the climbing cleaning robot is fixed on outer walls of the dust collecting plates;
a combining part combined with an upper side of the running body in order to locate the stage part at a predetermined height from the upper side of the running body;
a running device arranged between the running body and the stage part to move the running body in a Y-axis direction (in a back-and-forth direction); and
a running guide part combined with a lower side of the running body so as to guide the transfer robot to run along the rail by the running device.

3. The dust cleaning robot according to claim 2, wherein the rail comprises:
a horizontal plate formed long in a Y-axis direction; and
a vertical plate extending downwardly from right and left sides of the horizontal plate to support the ground, and
wherein the running device is seated and operated on the horizontal plate, and the running guide part supports the outer surface of the vertical plate.

4. The dust cleaning robot according to claim 2, wherein the stage part comprises:
a first driving part combined with one side of the upper side of the running body to generate driving power;
a base plate combined with the combining part;
a seating plate disposed at an upper side of the base plate, wherein the climbing cleaning robot is seated on the seating plate; and
a transfer guide part for moving the seating plate in an X-axis direction by operation of the first driving part.

5. The dust cleaning robot according to claim 3, wherein the running device comprises:
a second driving part combined with the other side of the upper portion of the running body to generate driving power;
a power transferring means for transferring driving power of the second driving part; and
a plurality of driving wheels connected with the power transferring means to rotate by receiving the driving power from the second driving part.

6. The dust cleaning robot according to claim 3, wherein the running guide part comprises:
one or more pairs of bracket parts combined with both sides of the floor surface of the running body;
rollers combined with the bracket parts and rotating in contact with the vertical plate of the rail; and
a combining means for combining the bracket parts with the running body to adjust a distance between a pair of the bracket parts.

7. The dust cleaning robot according to claim 4, wherein the combining part comprises:
a plurality of supporters vertically combined with the upper side of the running body and penetrating through a through hole formed in the base plate; and
a stopper combined with the supporters to fix the base plate at a predetermined height.

8. The dust cleaning robot according to claim 7, wherein the base plate comprises:
a clamping device mounted at the upper side thereof to combine and fix the supporters protruding to penetrate through the through holes; and
a cap disposed on the floor surface of the base plate, wherein the inner circumferential surface of the cap is formed to correspond to the outer circumferential surface of the stopper.

9. The dust cleaning robot according to claim 8, wherein the stopper surrounds the outer circumferential surface of the supporters, and the outer circumferential surface of the stopper is outwardly inclined in a radial direction toward a lower portion.

10. The dust cleaning robot according to claim 4, wherein the first driving part comprises:
a motor for generating driving power;
a motor shaft vertically formed at an upper portion of the motor to rotate by driving power of the motor; and
a pinion gear combined with the motor shaft.
